(19) United States
(12) Patent Application Publication
(10) Pub. No.: US 2019/0313418 A1
(43) Pub. Date: Oct. 10, 2019

(54) Transmission Apparatus and Method Based on Dynamic Time Division Duplex and Communication System

(71) Applicant: FUJITSU LIMITED, Kawasaki-shi (JP)

(72) Inventors: Weiwei WANG, Beijing (CN); Hua ZHOU, Beijing (CN); Xin WANG, Beijing (CN)

(73) Assignee: FUJITSU LIMITED, Kawasaki-shi (JP)

(21) Appl. No.: 16/450,268

(22) Filed: Jun. 24, 2019

Related U.S. Application Data
(63) Continuation of application No. PCT/CN2017/070470, filed on Jan. 6, 2017.

(51) Int. Cl. H04W 72/08; H04L 5/14; H04W 72/04

(52) U.S. Cl. CPC H04W 72/082; H04L 5/1469; H04W 72/042; H04W 72/0446; H04W 72/0413

(57) ABSTRACT

A transmission apparatus and method based on dynamic time division duplex and communication system. The transmission method includes: transmitting reporting information to a plurality of network equipments by user equipment, the reporting information indicating that cross-link interference occurs when the user equipment is scheduled by a first network equipment; receiving scheduling information transmitted by one of the plurality of network equipments; the scheduling information indicates that serving network equipment of the user equipment is changed from the first network equipment to a second network equipment; and performing data transmission by the user equipment with the second network equipment according to the scheduling information.

### CROSS REFERENCE TO RELATED APPLICATIONS

This application is a continuation application of International Application PCT/CN2017/070470 filed on Jan. 6, 2017, the entire contents of which are incorporated herein by reference.

### TECHNICAL FIELD

This disclosure relates to the field of communication technologies, and in particular to a transmission apparatus and method based on dynamic time division duplex (TDD) and a communication system.

### BACKGROUND

In a new radio (NR) system, dynamic TDD supports uplink and downlink configurations dynamically allocating data transmission by taking a time unit (such as a slot) as a basic unit. Hence, each transmission direction between a network equipment (such as a gNB) and a user equipment may possibly be changed dynamically by taking a time unit (such as a slot) as a basic unit.

FIG. 1 is a schematic diagram of a transmission direction of a dynamic TDD. As shown in FIG. 1, at a certain time unit (such as a first slot), a data transmission direction of a network equipment is of a downlink (DL), and at a next time unit (such as a second slot), the data transmission direction of the network equipment may possibly become into an uplink (UL).

If dynamic TDD is adopted in the NR system, the data transmission direction needs to be changed frequently, which may cause severe crosslink interference (CLI) between neighboring cells.

FIG. 2 is a schematic diagram of use of the dynamic TDD in the NR system. As shown in FIG. 2, in a certain slot, for example, a network equipment gNB1 transmits downlink data to a user equipment UE1 in a local cell (cell 1) by using the dynamic TDD, and a user equipment UE2 of a serving cell (cell 2) transmits uplink data to a network equipment gNB2 by using the dynamic TDD; crosslink interference may be generated between UE1 and UE2, and crosslink interference may also be generated between gNB1 and gNB2.

In order to reduce crosslink interference, a network equipment may adopt a mode of adjusting power of a user equipment, such as lowering power of the user equipment for transmitting uplink data; or it may adopt a mode of delaying scheduling a user equipment, such as delaying a time of the user equipment for transmitting uplink data by a slot.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that the existing mechanisms are based on an assumption that a user equipment is served by the same network equipment, which is lack of flexibility in scheduling a user equipment, and is disadvantageous to improvement of a spectral efficiency.

Embodiments of this disclosure provide a transmission apparatus and method based on dynamic time division duplex and communication system, in which in a case where cross-link interference occurs when a user equipment based on co-channel connectivity is scheduled, a serving network equipment is changed from a first network equipment into a second network equipment.

According to a first aspect of the embodiments of this disclosure, there is provided a transmission method based on dynamic time division duplex, including:

transmitting reporting information by a user equipment to a plurality of network equipments, the reporting information indicating that cross-link interference occurs when the user equipment is scheduled by a first network equipment;

receiving by the user equipment scheduling information transmitted by one of the plurality of network equipments; the scheduling information indicates that a serving network equipment of the user equipment is changed from the first network equipment to a second network equipment; and

performing data transmission by the user equipment with the second network equipment according to the scheduling information.

According to a second aspect of the embodiments of this disclosure, there is provided a transmission apparatus based on dynamic time division duplex, including:

an indication transmitting unit configured to transmit reporting information to a plurality of network equipments, the reporting information indicating that cross-link interference occurs when a user equipment (UE) is scheduled by a first network equipment;

a scheduling receiving unit configured to receive scheduling information transmitted by one of the plurality of network equipments; the scheduling information indicates that a serving network equipment of the UE is changed from the first network equipment to a second network equipment; and

a data transmitting unit configured to perform data transmission with the second network equipment according to the scheduling information.

According to a third aspect of the embodiments of this disclosure, there is provided a transmission method based on dynamic time division duplex, including:

receiving by a network equipment reporting information transmitted by a user equipment, the reporting information indicating that cross-link interference occurs when the user equipment is scheduled by a first network equipment;

generating scheduling information by the network equipment indicating that a serving network equipment of the user equipment is changed from the first network equipment to a second network equipment; and

transmitting the scheduling information by the network equipment to the user equipment, so that the user equipment performs data transmission with the second network equipment according to the scheduling information.

According to a fourth aspect of the embodiments of this disclosure, there is provided a transmission apparatus based on dynamic time division duplex, including:

an indication receiving unit configured to receive reporting information transmitted by a user equipment (UE), the reporting information indicating that cross-link interference occurs when the UE is scheduled by a first network equipment;

an information generating unit configured to generate scheduling information indicating that serving network equipment of the UE is changed from the first network equipment to a second network equipment; and

a scheduling transmitting unit configured to transmit the scheduling information to the UE, so that the UE performs data transmission with the second network equipment according to the scheduling information.

According to a fifth aspect of the embodiments of this disclosure, there is provided a communication system, including:

a user equipment including the transmission apparatus based on dynamic time division duplex as described in the second aspect; and

a network equipment including the transmission apparatus based on dynamic time division duplex as described in the fourth aspect.

An advantage of the embodiments of this disclosure exists in that in a case where cross-link interference occurs when a user equipment based on co-channel connectivity is scheduled, a serving network equipment is changed from a first network equipment into a second network equipment. Hence, flexibility of scheduling of the user equipment is improved, and a spectral efficiency is greatly improved.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals assign corresponding parts throughout the several views and may be used to assign like or similar parts in more than one embodiments.

FIG. 1 is a schematic diagram of a transmission direction of dynamic TDD;

FIG. 2 is a schematic diagram of use of dynamic TDD in an NR system;

FIG. 3 is a schematic diagram of a communication system of an embodiment of this disclosure;

FIG. 4 is a schematic diagram of the transmission method based on dynamic TDD of Embodiment 1 of this disclosure;

FIG. 5 is an exemplary diagram of co-channel multiple connectivity of Embodiment 1 of this disclosure;

FIG. 6 is another exemplary diagram of co-channel multiple connectivity of Embodiment 1 of this disclosure;

FIG. 7 is an exemplary diagram of posing cross-link interference by the user equipment of Embodiment 1 of this disclosure;

FIG. 8 is an exemplary diagram of being subjected to cross-link interference by the user equipment of Embodiment 1 of this disclosure;

FIG. 9 is another schematic diagram of the transmission method based on dynamic TDD of Embodiment 1 of this disclosure;

FIG. 10 is an exemplary diagram of data transmission based on dynamic TDD of Embodiment 1 of this disclosure;

FIG. 11 is another exemplary diagram of data transmission based on dynamic TDD of Embodiment 1 of this disclosure;

FIG. 12 is an exemplary diagram of data transmission based on dynamic TDD of Embodiment 1 of this disclosure;

FIG. 13 is another exemplary diagram of data transmission based on dynamic TDD of Embodiment 1 of this disclosure;

FIG. 14 is a schematic diagram of the transmission method based on dynamic TDD of Embodiment 2 of this disclosure;

FIG. 15 is a schematic diagram of the transmission apparatus based on dynamic TDD of Embodiment 3 of this disclosure;

FIG. 16 is a schematic diagram of the transmission apparatus based on dynamic TDD of Embodiment 4 of this disclosure;

FIG. 17 is a schematic diagram of the user equipment of Embodiment 5 of this disclosure; and

FIG. 18 is a schematic diagram of the network equipment of Embodiment 5 of this disclosure.

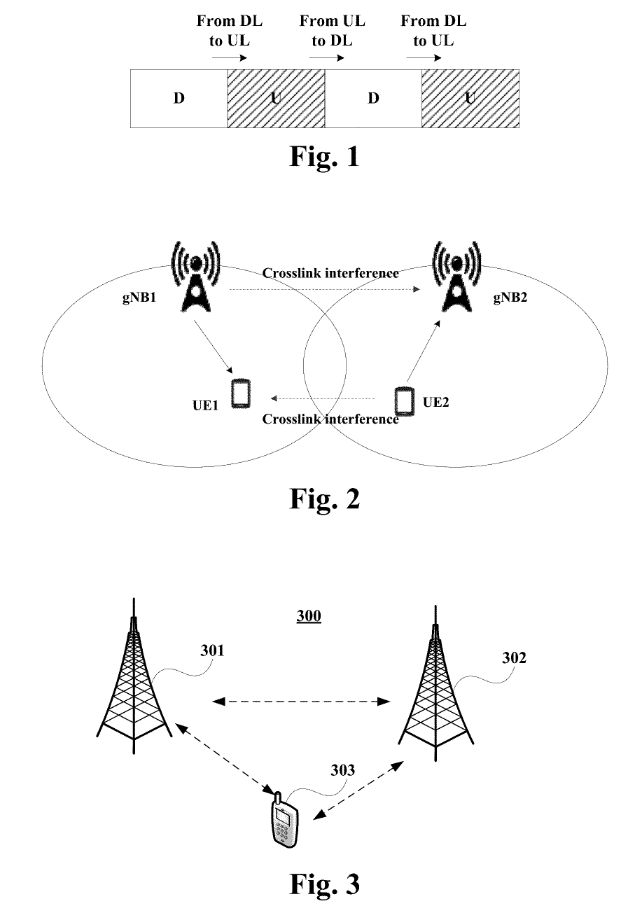

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, and/or other communication protocols that are currently known or will be developed in the future.

In the embodiments of this disclosure, the term “network equipment”, for example, refers to an equipment in a communication system that accesses a terminal equipment to the communication network and provides services for the terminal equipment. The network equipment may include but not limited to the following devices: a base station (BS), an access point (AP), a transmission reception point (TRP), a broadcast transmitter, a mobile management entity (MME), a gateway, a server, a radio network controller (RNC), a base station controller (BSC).

The base station may include but not limited to a node B (NodeB or NB), an evolved node B (eNodeB or eNB), and a 5G base station (gNB). Furthermore, it may include a remote radio head (RRH), a remote radio unit (RRU), a relay, or a low-power node (such as a femto, and a pico).

The term “base station” may include some or all of its functions, and each base station may provide communication coverage for a specific geographical area. And a term “cell” may refer to a base station and/or its coverage area, which is dependent on a context of the term.

In the embodiments of this disclosure, the term “user equipment (UE)” or “terminal equipment (TE)” refers to, for example, an equipment accessing to a communication network and receiving network services via a network equipment. The user equipment may be fixed or mobile, and may also be referred to as a mobile station (MS), a terminal, a subscriber station (SS), an access terminal (AT), or a station, etc.

The user equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal.

Scenarios in the embodiments of this disclosure shall be described below by way of examples; however, this disclosure is not limited thereto.

FIG. 3 is a schematic diagram of a communication system of an embodiment of this disclosure, in which a case where a user equipment and a network equipment are taken as examples is schematically shown. As shown in FIG. 3, a communication system 300 includes a network equipment 301, a network equipment 302 and a user equipment 303 (for the sake of simplicity, FIG. 3 shall be described by taking only one user equipment and two network equipments as an example).

In the embodiments of this disclosure, existing traffics or traffics that may be implemented in the future may be performed between the network equipments 301, 302 and the user equipment 303. For example, such traffics may include but not limited to an enhanced mobile broadband (eMBB), massive machine type communication (mMTC), and ultra-reliable and low-latency communication (URLLC).

Dynamic TDD is adopted between the network equipments 301, 302 and the user equipment 303 for uplink and downlink data transmission. And furthermore, the network equipments 301, 302 and the user equipment 303 are connected based on co-channel. For example, the user equipment 303 is connected to the network equipments 301 and 302 operating at identical frequencies, and data transmitted by user equipment 303 is received by the network equipments 301 and 302, and information transmitted by the network equipments 301 and 302 is received by the user equipment 303.

The embodiments of this disclosure shall be described below in detail by taking a gNB and a UE as an example.

### Embodiment 1

These embodiments of this disclosure provide a transmission method based on dynamic time division duplex, applicable to a user equipment; the user equipment is connected to a plurality of network equipments based on co-channel.

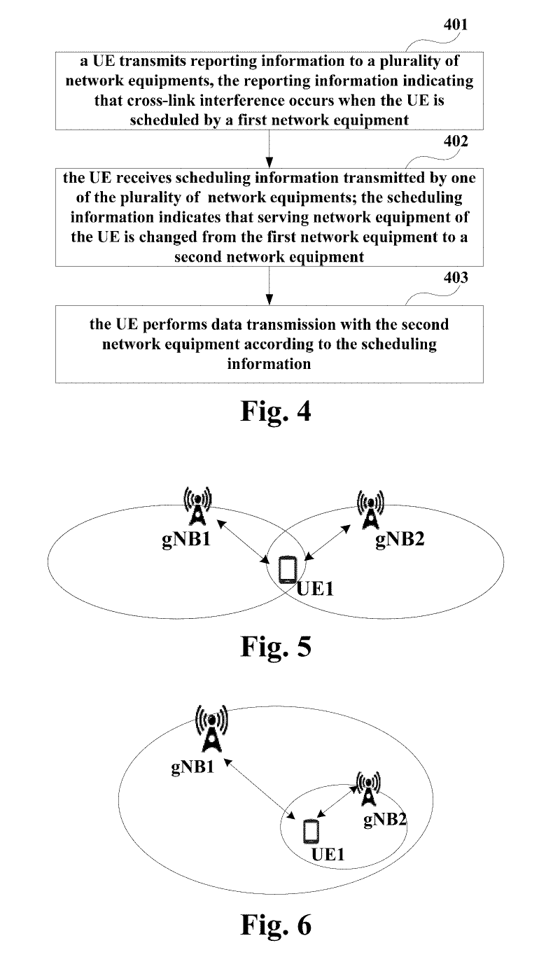

FIG. 4 is a schematic diagram of the transmission method based on dynamic TDD of the embodiment of this disclosure, which shall be described from a point of view of a user equipment. As shown in FIG. 4, the transmission method includes:

401: a user equipment transmits reporting information to a plurality of network equipments, the reporting information indicating that cross-link interference occurs when the user equipment is scheduled by a first network equipment;

402: the user equipment receives scheduling information transmitted by one of the plurality of network equipments; the scheduling information indicates that serving network equipment of the user equipment is changed from the first network equipment to a second network equipment; and

403: the user equipment performs data transmission with the second network equipment according to the scheduling information.

In some embodiments, the cross-link interference is reduced in a co-channel multiple connectivity manner. Under the co-channel multiple connectivity mechanism, one user equipment is simultaneously connected to a plurality of network equipments (such as TRPs) operating at identical frequencies, in which case data transmitted by one user equipment is received by a plurality of network equipments (such as TRPs), or information transmitted by a plurality of network equipments (such as TRPs) is received by one user equipment.

FIG. 5 is an exemplary diagram of the co-channel multiple connectivity of the embodiment of this disclosure. As shown in FIG. 5, UE1 is connected to both gNB1 and gNB2 operating at identical frequencies (e.g., f1). For example, if UE1 is scheduled by gNB2 for performing uplink data transmission at a certain time unit (e.g. slot 1), gNB2 may be referred to as a serving network equipment of UE1 at that time unit (e.g. slot 1).

FIG. 6 is another exemplary diagram of the co-channel multiple connectivity of the embodiment of this disclosure. As shown in FIG. 6, UE1 is connected to both gNB1 and gNB2 operating at identical frequencies (e.g., f2). For example, if UE1 is scheduled by gNB1 for performing downlink data reception at a certain time unit (e.g. slot 2), gNB1 may be referred to as a serving network equipment of UE1 at that time unit (e.g. slot 2).

In some embodiments, when a certain user equipment is scheduled by a certain network equipment, cross-link interference may possibly occur; the user equipment may perform interference measurement according to resource configuration information of the network equipment, thereby detecting that cross-link interference occurs. Reference may be made to the relevant art for how to particularly perform measurement of the cross-link interference, which shall not be described herein any further.

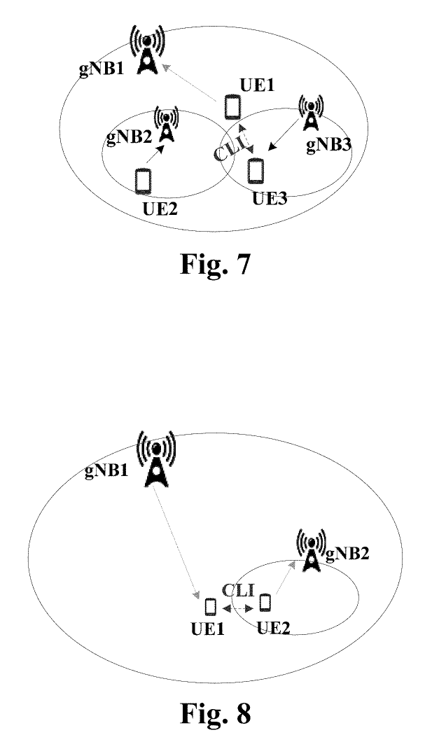

FIG. 7 is an exemplary diagram of posing cross-link interference by the user equipment of the embodiment of this disclosure. As shown in FIG. 7, at a certain time unit (e.g. slot 1), UE1 and gNB1 perform uplink data transmission, UE3 and gNB3 perform downlink data transmission, and UE1 poses cross-link interference to UE3.

FIG. 8 is an exemplary diagram of being subjected to cross-link interference by the user equipment of the embodiment of this disclosure. As shown in FIG. 8, at a certain time unit (e.g. slot 2), UE1 and gNB1 perform downlink data transmission, UE2 and gNB2 perform uplink data transmission, and UE1 is subjected to cross-link interference from UE2.

In some embodiments, in a case where the user equipment detects cross-link interference occurs (it poses interference to other user equipments, and/or is subjected to interference from other user equipments), it transmits the reporting information to a plurality of network equipments based on co-channel connectivity, and changes the serving network equipment based on the scheduling information.

For example, the user equipment transmits the reporting information to the plurality of network equipments in a case where strength of cross-link interference posed to other user equipments by the user equipment when the user equipment is scheduled by the first network equipment exceeds a first predetermined threshold;

and/or the user equipment transmits the reporting information to the plurality of network equipments in a case where strength of cross-link interference to which the user equipment is subjected from other user equipments when the UE is scheduled by the first network equipment exceeds a second predetermined threshold.

It should be noted that the first predetermined threshold or the second predetermined threshold may be pre-configured by the network equipment, or may be predefined or preset. And furthermore, a particular numeral value of the first predetermined threshold or the second predetermined threshold may be determined according to, for example, an empirical value, and this disclosure is not limited thereto.

In some embodiments, the reporting information includes one or more pieces of the following information:
indication information on whether the UE poses cross-link interference to the other UEs;
identification information on serving network equipment where the UE is present when the UE poses cross-link interference to the other UEs, such as identification information of a gNB (a gNB ID), or identification information of a cell (a cell ID);
strength information or strength indication information on cross-link interference posed by the UE to the other UEs, such as signal-to-interference plus noise ratio (SINR), or interference noise ratio (INR);
indication information on whether the UE is subjected to cross-link interference from the other UEs;
identification information on serving network equipment where the UE is present when the UE is subjected to cross-link interference from the other UEs, such as identification information of a gNB (a gNB ID), or identification information of a cell (a cell ID); and
strength information or strength indication information on cross-link interference from the other UEs to which the UE is subjected, such as an SINR or an INR.

It should be noted that the reporting information is only schematically described above. However, this disclosure is not limited thereto, for example, other reporting information may also be included.

In some embodiments, after the plurality of network equipments based on the co-channel connectivity receive the reporting information, one or more thereof determine whether to change the service network equipment of the user equipment based on a predetermined condition or consensus, and further determine which network equipment serves for the user equipment. And a certain network equipment generates the scheduling information and transmits the scheduling information to the user equipment.

In some embodiments, the scheduling information is further used to indicate that a transmission direction of the UE is changed. That is, the scheduling information indicates that the serving network equipment is changed but the transmission direction of the user equipment is not changed; or the serving network equipment is changed and the transmission direction of the user equipment is changed.

In some embodiments, the scheduling information includes one or more pieces of the following information:
indication information on the serving network equipment of the UE, such as identification information of a gNB (a gNB ID), or identification information of a cell (a cell ID);
information on a scheduled transmission direction of the UE;
information on positions of resources allocated for the UE;
information on a modulation coding scheme adopted in data transmission;
information on power adopted when the UE is scheduled to perform uplink data transmission; and
information on a time adopted when the UE is scheduled to perform uplink data transmission, such as time advance information (TAI).

It should be noted that the scheduling information is only schematically described above. However, this disclosure is not limited thereto, for example, other scheduling information may also be included.

In some embodiments, the network equipment includes scheduling information needing to be transmitted in signaling, and transmits the scheduling information to the user equipment in operation 402. Alternatively, a part of the one or more pieces of information is indicated by the scheduling information, and a part thereof is preconfigured via signaling.

For example, the gNB contains the identification information of the serving gNB only in the scheduling information, and other information (such as the transmission direction of the scheduled user equipment, and positions of allocated resources) has configured for the user equipment via other signaling (such as radio resource control (RRC) signaling, media access control (MAC) layer signaling); after receiving the scheduling information, the user equipment automatically determines other information corresponding to the identification information of the service gNB, and performs data reception and transmission according to the other information.

In some embodiments, the scheduling information further includes an index indicating one or more pieces of the above information. That is, contents in the above scheduling information may be denoted by an identifier (or an index), each identifier corresponding to contents of a type of scheduling information. And the gNB transmits only an identifier of the scheduling information in the scheduling information, so that the user equipment determines the contents of the scheduling information according to the identifier.

For example, index 1 corresponds to gNB1, uplink, and power of 10, . . . ; index 2 corresponds to gNB2, uplink, and power of 8, . . . ; index 3 corresponds to gNB3, downlink, . . . . Then, the network equipment may only contain 2 in the scheduling information (indicating that information to which index 2 corresponds is adopted), and the user equipment may change the serving network equipment to gNB2 according to the scheduling information, and perform uplink transmission with power of 8.

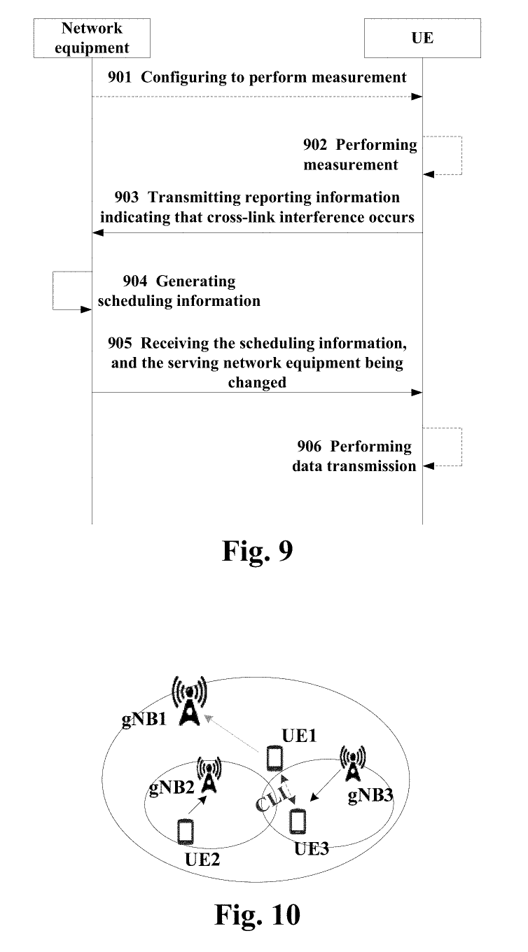

FIG. 9 is another schematic diagram of the transmission method based on dynamic TDD of the embodiment of this disclosure, in which description is given from the points of view of the network equipment and the user equipment. As shown in FIG. 9, the transmission method includes:

901: the network equipment configures the user equipment to perform measurement of cross-link interference.

902: the user equipment performs measurement of cross-link interference.

903: the user equipment transmits reporting information indicating that cross-link interference occurs to the network equipment.

In some embodiments, the user equipment transmits the reporting information to a plurality of network equipments in a case where strength of cross-link interference posed to other UEs by the UE when the UE is scheduled by the first network equipment exceeds a first predetermined threshold, and/or, strength of cross-link interference to which the UE is subjected from other UEs when the UE is scheduled by the first network equipment exceeds a second predetermined threshold.

904: the network equipment generates the scheduling information.

In some embodiments, after the plurality of network equipments based on the co-channel connectivity receive the reporting information, one or more thereof determine whether to change the service network equipment of the user equipment based on a predetermined condition or consensus, and further determine which network equipment serves for the user equipment; and a certain network equipment generates the scheduling information and transmits the scheduling information to the user equipment.

905: the user equipment receives the scheduling information; the scheduling information indicates that the serving network equipment of the user equipment is changed from the first network equipment to the second network equipment; and

906: the user equipment performs data transmission with a network equipment.

For example, data transmission based on dynamic TDD is performed with the changed second network equipment; however, this disclosure is not limited thereto, and, for example, it may not be data transmission of dynamic TDD.

It should be noted that the embodiments of this disclosure are only illustrated in FIG. 9; however, this disclosure is not limited thereto. For example, an order of execution of the operations may be appropriately adjusted; and furthermore, some other operations may be added, or some of these operations may be reduced. And appropriate variants may be made by those skilled in the art according to what is described above, without being limited to the disclosure contained in FIG. 9.

Furthermore, the network equipment configured for measurement in operation 901, the network equipment generating the scheduling information in operation 904, and the network equipment performing scheduling in operation 906 may not be the same network equipment; and of course, they may be the same network equipment. And for the sake of simplicity, they are not differentiated FIG. 9.

Further description is given below by way of two examples.

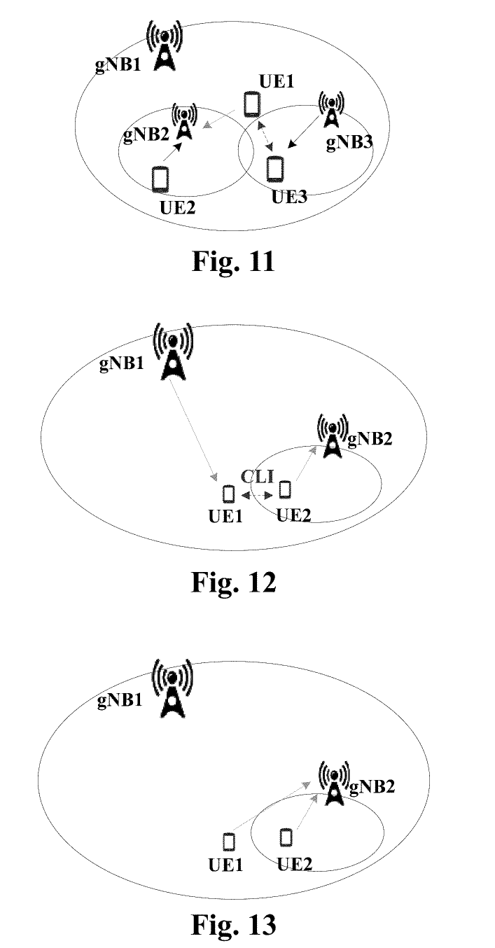

FIG. 10 is an exemplary diagram of data transmission based on dynamic TDD of the embodiment of this disclosure, showing a situation before changing a serving network equipment. As shown in FIG. 10, UE1 is scheduled at a certain time unit (e.g. slot 1) to transmit uplink data to gNB1 (which may include receiving scheduling information for transmitting uplink data to gNB1, or finishing transmission of uplink data to gNB1); at the time unit (e.g. time slot 1), UE1 and gNB1 perform uplink data transmission, UE3 and gNB3 perform downlink data transmission, and UE1 detects that cross-link interference occurs (UE1 poses cross-link interference to UE3).

UE1 may transmit cross-link interference indication information to gNB1, gNB2 and gNB3 based on co-channel connectivity. A network equipment in gNB1, gNB2 and gNB3 (e.g. gNB2) may generate and transmit the scheduling information to change a serving gNB of UE1 from gNB1 to gNB2, but the transmission direction is not changed.

FIG. 11 is another exemplary diagram of data transmission based on dynamic TDD of the embodiment of this disclosure, showing a situation after changing a service network equipment. As shown in FIG. 11, the serving gNB of UE1 is changed to gNB2, and at a certain time unit (e.g. slot 2), UE1 and gNB2 perform uplink data transmission, and UE3 and gNB3 perform downlink data transmission. Since power of gNB2 and UE1 for transmitting the data may be relatively small, cross-link interference between UE1 and UE3 may be greatly lowered.

An example in which the service network equipment is changed but the transmission direction is not changed is schematically shown above, and an example in which both the service network equipment and the transmission direction are changed shall be shown below.

FIG. 12 is an exemplary diagram of data transmission based on dynamic TDD of the embodiment of this disclosure, showing a situation before changing a service network equipment. As shown in FIG. 12, UE1 is scheduled at a certain time unit (e.g. slot 1) to receive downlink data transmitted by gNB1 (which may include receiving scheduling information on receiving downlink data of gNB1), or finishing reception of the downlink data transmitted by tgNB1); at this time unit (e.g. time slot 1), UE1 and gNB1 perform downlink data transmission, UE2 and gNB2 perform uplink data transmission, and UE1 detects cross-link interference occurs (UE1 is subjected to cross-link interference from UE2).

UE1 may transmit cross-link interference indication information to gNB1 and gNB2 based on co-channel connectivity. A network equipment in gNB1 and gNB2 (e.g. gNB2) may generate and transmit the scheduling information to change a serving gNB of UE1 from gNB1 to gNB2, and the transmission direction is changed (which is changed from downlink into uplink).

FIG. 13 is another exemplary diagram of data transmission based on dynamic TDD of the embodiment of this disclosure, showing a situation after changing a service network equipment. As shown in FIG. 13, the serving gNB of UE1 is changed to gNB2, and at a certain time unit (e.g. slot 2), UE1 and gNB2 perform uplink data transmission, and UE2 and gNB2 perform uplink data transmission, and cross-link interference between UE1 and UE2 is generated no longer.

It can be seen from the above embodiments that in a case where cross-link interference occurs when a user equipment based on co-channel connectivity is scheduled, a serving network equipment is changed from a first network equipment into a second network equipment. Hence, flexibility of scheduling of the user equipment is improved, and a spectral efficiency is greatly improved.

### Embodiment 2

These embodiments of this disclosure provide a transmission method based on dynamic time division duplex, applicable to a network equipment, with contents identical to those in Embodiment 1 being not going to be described herein any further.

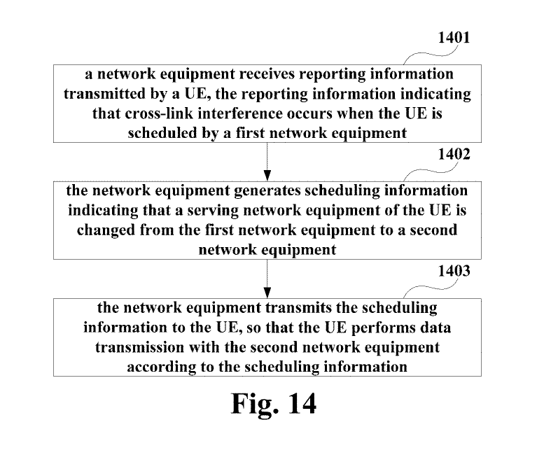

FIG. 14 is a schematic diagram of the transmission method based on dynamic TDD of the embodiment of this disclosure, which shall be described from a point of view of a network equipment. As shown in FIG. 14, the transmission method includes:

1401: a network equipment receives reporting information transmitted by a user equipment, the reporting information indicating that cross-link interference occurs when the UE is scheduled by a first network equipment.

1402: the network equipment generates scheduling information indicating that a serving network equipment of the UE is changed from the first network equipment to a second network equipment; and

1403: the network equipment transmits the scheduling information to the UE, so that the UE performs data transmission with the second network equipment according to the scheduling information.

In some embodiments, the UE transmits the reporting information to a plurality of network equipments based on co-channel connectivity in a case where strength of cross-link interference posed to other UEs by the UE when the UE is scheduled by the first network equipment exceeds a first predetermined threshold, and/or strength of cross-link interference to which the UE is subjected from other UEs when the UE is scheduled by the first network equipment exceeds a second predetermined threshold.

In some embodiments, the scheduling information is further used to indicate that a transmission direction of the UE is changed.

In some embodiments, the reporting information includes one or more pieces of the following information: indication information on whether the UE poses cross-link interference to the other UEs; identification information on serving network equipment where the UE is present when the UE poses cross-link interference to the other UEs; strength information or strength indication information on cross-link interference posed by the UE to the other UEs; indication information on whether the UE is subjected to cross-link interference from the other UEs; identification information on serving network equipment where the UE is present when the UE is subjected to cross-link interference from the other UEs; strength information or strength indication information on cross-link interference from the other UEs to which the UE is subjected. However, this disclosure is not limited thereto.

In some embodiments, the scheduling information includes one or more pieces of the following information: indication information on the serving network equipment of the UE; information on a scheduled transmission direction of the UE; information on positions of resources allocated for the UE; information on a modulation coding scheme adopted in data transmission; information on power adopted when the UE is scheduled to perform uplink data transmission; information on a time adopted when the UE is scheduled to perform uplink data transmission. However, this disclosure is not limited thereto.

Furthermore, a part of the one or more pieces of the information may be indicated by the scheduling information, and a part of the one or more pieces of the information may be preconfigured via signaling. Or, the scheduling information may include index (indices) of the one or more pieces of information.

In some embodiments, the network equipment further configures the UE to perform measurement on cross-link interference.

It can be seen from the above embodiments that in a case where cross-link interference occurs when a user equipment based on co-channel connectivity is scheduled, a serving network equipment is changed from a first network equipment into a second network equipment. Hence, flexibility of scheduling of the user equipment is improved, and a spectral efficiency is greatly improved.

### Embodiment 3

These embodiments of this disclosure provide a transmission apparatus based on dynamic time division duplex, which may be, for example, a user equipment connected to a plurality of network equipments based on co-channel connectivity, or may be one or more parts or components configured in a user equipment. Contents in these embodiments identical to those in Embodiment 1 shall not be described herein any further.

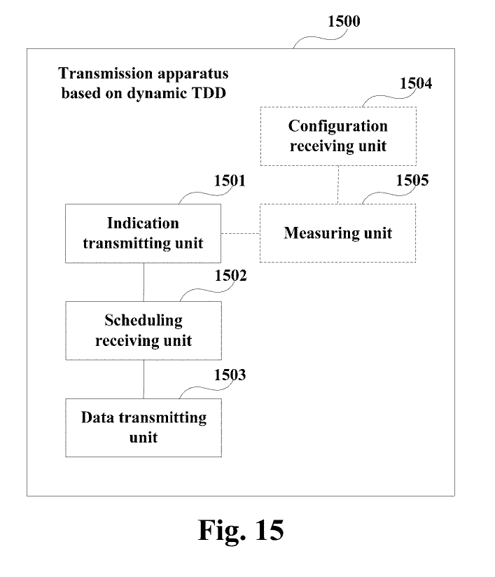

FIG. 15 is a schematic diagram of the transmission apparatus based on dynamic TDD of the embodiment of this disclosure. As shown in FIG. 15, a transmission apparatus 1500 based on dynamic TDD includes:

an indication transmitting unit 1501 configured to transmit reporting information to a plurality of network equipments based on co-channel connectivity, the reporting information indicating that cross-link interference occurs when a user equipment (UE) is scheduled by a first network equipment;

a scheduling receiving unit 1502 configured to receive scheduling information transmitted by one of the plurality of network equipments; the scheduling information indicates that a serving network equipment of the UE is changed from the first network equipment to a second network equipment; and

a data transmitting unit 1503 configured to perform data transmission with the second network equipment according to the scheduling information.

In some embodiments, the indication transmitting unit 1501 is configured to transmit the reporting information to the plurality of network equipments in a case where strength of cross-link interference posed to other UEs by the UE when the UE is scheduled by the first network equipment exceeds a first predetermined threshold, and/or strength of cross-link interference to which the UE is subjected from other UEs when the UE is scheduled by the first network equipment exceeds a second predetermined threshold.

In some embodiments, the scheduling information is further used to indicate that a transmission direction of the UE is changed.

In some embodiments, the reporting information includes one or more pieces of the following information: indication information on whether the UE poses cross-link interference to the other UEs; identification information on serving network equipment where the UE is present when the UE poses cross-link interference to the other UEs; strength information or strength indication information on cross-link interference posed by the UE to the other UEs; indication information on whether the UE is subjected to cross-link interference from the other UEs; identification information on serving network equipment where the UE is present when the UE is subjected to cross-link interference from the other UEs; strength information or strength indication information on cross-link interference from the other UEs to which the UE is subjected.

In some embodiments, the scheduling information includes one or more pieces of the following information: indication information on the serving network equipment of the UE; information on a scheduled transmission direction of the UE; information on positions of resources allocated for the UE; information on a modulation coding scheme adopted in data transmission; information on power adopted when the UE is scheduled to perform uplink data transmission; information on a time adopted when the UE is scheduled to perform uplink data transmission.

In some embodiments, a part of the one or more pieces of the information is indicated by the scheduling information, and a part of the one or more pieces of the information is preconfigured via signaling. Or, the scheduling information further include index (indices) of the one or more pieces of information.

As shown in FIG. 15, the transmission apparatus 1500 based on dynamic TDD may further include:

a configuration receiving unit 1504 configured to receive configuration information for performing measurement on cross-link interference configured by the network equipment; and

a measuring unit 1505 configured to perform measurement on cross-link interference.

It should be noted that the components or modules related to this disclosure are only illustrated above; however, this disclosure is not limited thereto. And the transmission apparatus 1500 based on dynamic TDD may further include other components or modules, and reference may be made to related techniques for particular contents of these components or modules.

It can be seen from the above embodiments that in a case where cross-link interference occurs when a user equipment based on co-channel connectivity is scheduled, a serving network equipment is changed from a first network equipment into a second network equipment. Hence, flexibility of scheduling of the user equipment is improved, and a spectral efficiency is greatly improved.

### Embodiment 4

These embodiments of this disclosure provide a transmission apparatus based on dynamic time division duplex, which may be a network equipment, or may be one or more parts or components configured in a network equipment. Contents in this embodiment identical to those in Embodiment 2 shall not be described herein any further.

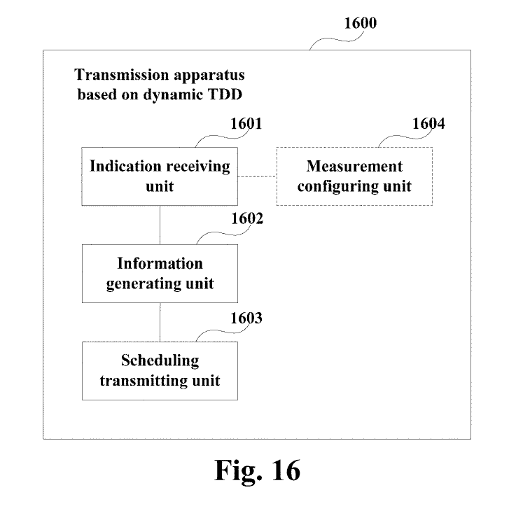

FIG. 16 is a schematic diagram of the transmission apparatus based on dynamic TDD of the embodiment of this disclosure. As shown in FIG. 16, a transmission apparatus 1600 based on dynamic TDD includes:

an indication receiving unit 1601 configured to receive reporting information transmitted by a user equipment (UE), the reporting information indicating that cross-link interference occurs when the UE is scheduled by a first network equipment;

an information generating unit 1602 configured to generate scheduling information indicating that a serving network equipment of the UE is changed from the first network equipment to a second network equipment; and

a scheduling transmitting unit 1603 configured to transmit the scheduling information to the UE, so that the UE performs data transmission with the second network equipment according to the scheduling information.

In some embodiments, the UE transmits the reporting information to a plurality of network equipments based on co-channel connectivity in a case where strength of cross-link interference posed to other UEs by the UE when the UE is scheduled by the first network equipment exceeds a first predetermined threshold, and/or strength of cross-link interference to which the UE is subjected from other UEs when the UE is scheduled by the first network equipment exceeds a second predetermined threshold.

In some embodiments, the scheduling information is further used to indicate that a transmission direction of the UE is changed.

In some embodiments, the reporting information includes one or more pieces of the following information: indication information on whether the UE poses cross-link interference to the other UEs; identification information on serving network equipment where the UE is present when the UE poses cross-link interference to the other UEs; strength information or strength indication information on cross-link interference posed by the UE to the other UEs; indication information on whether the UE is subjected to cross-link interference from the other UEs; identification information on serving network equipment where the UE is present when the UE is subjected to cross-link interference from the other UEs; strength information or strength indication information on cross-link interference from the other UEs to which the UE is subjected.

In some embodiments, the scheduling information includes one or more pieces of the following information: indication information on the serving network equipment of the UE; information on a scheduled transmission direction of the UE; information on positions of resources allocated for the UE; information on a modulation coding scheme adopted in data transmission; information on power adopted when the UE is scheduled to perform uplink data transmission; information on a time adopted when the UE is scheduled to perform uplink data transmission.

In some embodiments, a part of the one or more pieces of the information is indicated by the scheduling information, and a part of the one or more pieces of the information is preconfigured via signaling. Or, the scheduling information include index (indices) of the one or more pieces of information.

As shown in FIG. 16, the transmission apparatus 1600 based on dynamic TDD may further include:

a measurement configuring unit 1604 configured to configure the UE to perform measurement on cross-link interference.

It should be noted that the components or modules related to this disclosure are only illustrated above; however, this disclosure is not limited thereto. And the transmission apparatus 1600 based on dynamic TDD may further include other components or modules, and reference may be made to related techniques for particular contents of these components or modules.

It can be seen from the above embodiments that in a case where cross-link interference occurs when a user equipment based on co-channel connectivity is scheduled, a serving network equipment is changed from a first network equipment into a second network equipment. Hence, flexibility of scheduling of the user equipment is improved, and a spectral efficiency is greatly improved.

### Embodiment 5

These embodiments of this disclosure provide a communication system, reference being able to be made to FIG. 3, and contents identical to those in embodiments 1-4 being not going to be described herein any further. In some embodiments, the communication system 300 includes:

a user equipment 303 configured with the transmission apparatus 1500 based on dynamic TDD as described in Embodiment 3; and

a network equipment 301 or 302 configured with the transmission apparatus 1600 based on dynamic TDD as described in Embodiment 4.

The embodiment of this disclosure further provides a user equipment; however, this disclosure is not limited thereto, and may also be other devices.

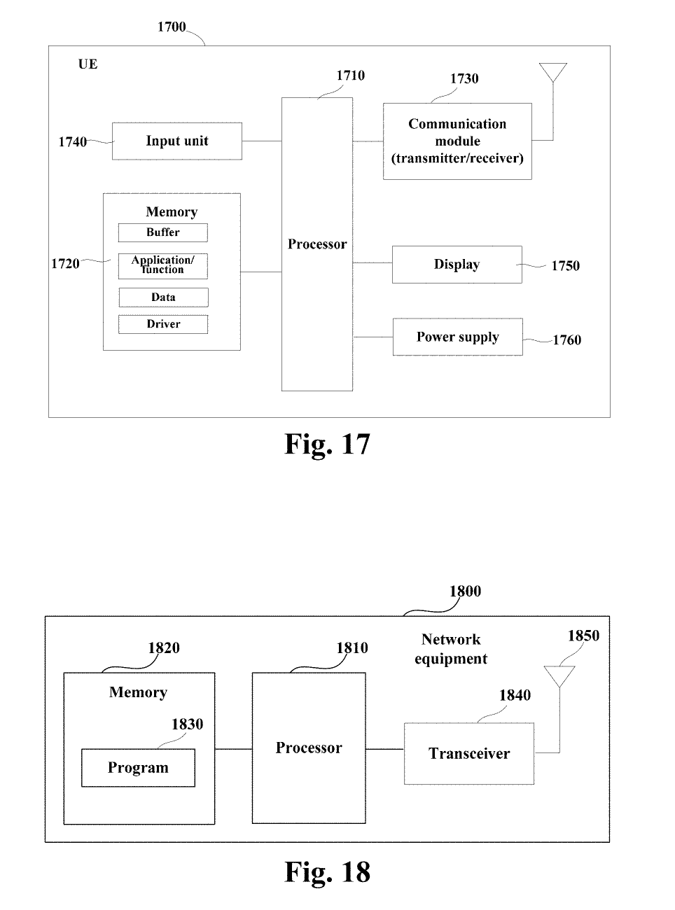

FIG. 17 is a schematic diagram of the user equipment of the embodiment of this disclosure. As shown in FIG. 17, a user equipment 1700 includes a processor 1710 and a memory 1720, the memory 1720 storing data and programs and being coupled to the processor 1710. It should be noted that this figure is illustrative only, and other types of structures may also be used, so as to supplement or replace this structure and achieve a telecommunications function or other functions.

The processor 1710 may be configured to execute the functions of the transmission apparatus 1500 based on dynamic TDD. For example, the processor 1710 may be configured to perform the following control: transmitting reporting information to a plurality of network equipments based on co-channel connectivity, the reporting information indicating that cross-link interference occurs when the user equipment is scheduled by a first network equipment; receiving scheduling information transmitted by one of the plurality of network equipments; the scheduling information indicates that a serving network equipment of the user equipment is changed from the first network equipment to a second network equipment; and performing data transmission with the second network equipment according to the scheduling information.

As shown in FIG. 17, the user equipment 1700 may further include a communication module 1730, an input unit 1740, a display 1750 and a power supply 1760. Functions of the above components are similar to those in the relevant art, and shall not be described herein any further. It should be noted that the user equipment 1700 does not necessarily include all the parts shown in FIG. 17, and the above components are not necessary; and furthermore, the user equipment 1700 may include parts not shown in FIG. 17, and the relevant art may be referred to.

The embodiment of this disclosure further provides a network equipment, such as a base station; however, this disclosure is not limited thereto, and may also be other network equipments.

FIG. 18 is a schematic diagram of a structure of the network equipment of the embodiment of this disclosure. As shown in FIG. 18, a network equipment 1800 may include a processor 1810 (such as a central processing unit (CPU)) and a memory 1820, the memory 1820 being coupled to the processor 1810. The memory 1820 may store various data, and furthermore, it may store a program 1830 for data processing, and execute the program 1830 under control of the processor 1810.

The processor 1810 may be configured to execute the functions of the transmission apparatus 1600 based on dynamic TDD. For example, the processor 1810 may be configured to perform the following control by executing the program 1830: receiving reporting information transmitted by a user equipment, the reporting information indicating that cross-link interference occurs when the user equipment is scheduled by a first network equipment; generating scheduling information indicating that a serving network equipment of the user equipment is changed from the first network equipment to a second network equipment; and transmitting the scheduling information to the user equipment, so that the user equipment performs data transmission with the second network equipment according to the scheduling information.

Furthermore, as shown in FIG. 18, the network equipment 1800 may include a transceiver 1840, and an antenna 1850, etc. Functions of the above components are similar to those in the relevant art, and shall not be described herein any further. It should be noted that the network equipment 1800 does not necessarily include all the parts shown in FIG. 18, and furthermore, the network equipment 1800 may include parts not shown in FIG. 18, and the relevant art may be referred to.

An embodiment of the present disclosure provides a computer readable program code, which, when executed in a user equipment, may cause the user equipment to carry out the transmission method based on dynamic TDD as described in Embodiment 1.

An embodiment of the present disclosure provides a computer storage medium, including a computer readable program code, which may cause a user equipment to carry out the transmission method based on dynamic TDD as described in Embodiment 1.

An embodiment of the present disclosure provides a computer readable program code, which, when executed in a network equipment (such as a base station), may cause the network equipment (such as the base station) to carry out the transmission method based on dynamic TDD as described in Embodiment 2.

An embodiment of the present disclosure provides a computer storage medium, including a computer readable program code, which may cause a network equipment (such as a base station) to carry out the transmission method based on dynamic TDD as described in Embodiment 2.

The above apparatuses of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory.

The method/apparatus described with reference to the embodiments of this disclosure may be directly embodied as hardware, software modules executed by a processor, or a combination thereof. For example, one or more functional block diagrams and/or one or more combinations of the functional block diagrams shown in FIG. 15 may either correspond to software modules of procedures of a computer program, or correspond to hardware modules. Such software modules may respectively correspond to the steps shown in FIG. 4. And the hardware module, for example, may be carried out by firming the soft modules by using a field programmable gate array (FPGA).

The soft modules may be located in an RAM, a flash memory, an ROM, an EPROM, and an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the accompanying drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the accompanying drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. A user equipment (UE) based on dynamic time division duplex, comprising:
a transmitter configured to transmit reporting information to a plurality of network equipments based on co-channel connectivity, the reporting information indicating that cross-link interference occurs when the UE is scheduled by a first network equipment;
a receiver configured to receive scheduling information transmitted by a second network equipments; wherein, the scheduling information indicates that a serving network equipment of the UE is changed from the first network equipment to the second network equipment; and
a processor configured to perform data transmission with the second network equipment according to the scheduling information.

2. The UE according to claim 1, wherein the transmitter is configured to transmit the reporting information to the plurality of network equipments in a case where strength of cross-link interference posed to one or more other UEs by the UE when the UE is scheduled by the first network equipment exceeds a first predetermined threshold, and/or, strength of cross-link interference to which the UE is subjected from one or more other UEs when the UE is scheduled by the first network equipment exceeds a second predetermined threshold.

3. The UE according to claim 1, wherein the scheduling information is further used to indicate that a transmission direction of the UE is changed.

4. The UE according to claim 1, wherein the reporting information comprises one or more pieces of the following information:
indication information on whether the UE poses cross-link interference to one or more other UEs;
identification information on serving network equipment where the UE is present when the UE poses cross-link interference to the other UEs;
strength information or strength indication information on cross-link interference posed by the UE to the other UEs;
indication information on whether the UE is subjected to cross-link interference from the other UEs;
identification information on serving network equipment where the UE is present when the UE is subjected to cross-link interference from the other UEs;
strength information or strength indication information on cross-link interference from the other UEs to which the UE is subjected.

5. The UE according to claim 1, wherein the scheduling information comprises one or more pieces of the following information, or the scheduling information comprises index (indices) of one or more pieces of the following information:
indication information on the serving network equipment of the UE;
information on a scheduled transmission direction of the UE;
information on positions of resources allocated for the UE;
information on a modulation coding scheme adopted in data transmission;
information on power adopted when the UE is scheduled to perform uplink data transmission; and
information on a time adopted when the UE is scheduled to perform uplink data transmission.

6. The UE according to claim 5, wherein a part of the one or more pieces of the information is indicated by the scheduling information, and a part of the one or more pieces of the information is preconfigured via signaling.

7. The UE according to claim 1, wherein the receiver is further configured to receive configuration information for performing measurement on cross-link interference configured by the network equipment; and
the processor is further configured to perform measurement on cross-link interference.

8. A network equipment based on dynamic time division duplex, comprising:
a receiver configured to receive reporting information transmitted by a user equipment (UE), the reporting information indicating that cross-link interference occurs when the UE is scheduled by a first network equipment;
a processor configured to generate scheduling information indicating that a serving network equipment of the UE is changed from the first network equipment to a second network equipment; and
a transmitter configured to transmit the scheduling information to the UE, the scheduling information being used by the UE to perform data transmission with the second network equipment.

9. The network equipment according to claim 8, wherein the UE is configured to transmit the reporting information to a plurality of network equipments based on co-channel connectivity in a case where strength of cross-link interference posed to one or more other UEs by the UE when the UE is scheduled by the first network equipment exceeds a first predetermined threshold, and/or, strength of cross-link interference to which the UE is subjected from one or more other UEs when the UE is scheduled by the first network equipment exceeds a second predetermined threshold.

10. The network equipment according to claim 8, wherein the scheduling information is further used to indicate that a transmission direction of the UE is changed.

11. The network equipment according to claim 8, wherein the reporting information comprises one or more pieces of the following information:
indication information on whether the UE poses cross-link interference to one or more other UEs;
identification information on serving network equipment where the UE is present when the UE poses cross-link interference to the other UEs;
strength information or strength indication information on cross-link interference posed by the UE to the other UEs;
indication information on whether the UE is subjected to cross-link interference from the other UEs;
identification information on serving network equipment where the UE is present when the UE is subjected to cross-link interference from the other UEs;
strength information or strength indication information on cross-link interference from the other UEs to which the UE is subjected.

12. The network equipment according to claim 8, wherein the scheduling information comprises one or more pieces of the following information, or the scheduling information comprises index (indices) of one or more pieces of the following information:
indication information on the serving network equipment of the UE;
information on a scheduled transmission direction of the UE;
information on positions of resources allocated for the UE;
information on a modulation coding scheme adopted in data transmission;
information on power adopted when the UE is scheduled to perform uplink data transmission; and
information on a time adopted when the UE is scheduled to perform uplink data transmission.

13. The network equipment according to claim 12, wherein a part of the one or more pieces of the information is indicated by the scheduling information, and a part of the one or more pieces of the information is preconfigured via signaling.

14. The network equipment according to claim 8, wherein the processor is further configured to configure the UE to perform measurement on cross-link interference.

15. A communication system, comprising:
a user equipment configured to transmit reporting information to a plurality of network equipments based on co-channel connectivity, the reporting information indicating that cross-link interference occurs when the UE is scheduled by a first network equipment; receive scheduling information transmitted by a second network equipments; wherein, the scheduling information indicates that a serving network equipment of the UE is changed from the first network equipment to the second network equipment; and perform data transmission with the second network equipment according to the scheduling information; and
a network equipment configured to receive the reporting information transmitted by the UE; generate and transmit the scheduling information to the UE.
